(19) United States
(12) Patent Application Publication
(10) Pub. No.: US 2015/0165669 A1
(43) Pub. Date: Jun. 18, 2015

(54) Moulded Product and Method

(71) Applicant: Jackel Trade Marks Pty Limited, Rydalmere, OT (AU)

(72) Inventor: Arnold Rees, Newcastle upon Tyne (GB)

(21) Appl. No.: 14/416,965

(22) PCT Filed: Jul. 23, 2013
(86) PCT No.: PCT/AU2013/000808

§ 371 Date: Jan. 23, 2015

(30) Foreign Application Priority Data
Jul. 23, 2012 (AU) 2012903122

(51) Int. Cl. B29C 49/20; B65D 1/02; B65D 1/42

(52) U.S. Cl. CPC B29C 49/20; B65D 1/42; B65D 1/0223; B29C 2049/2069; B29K 2023/00

(57) ABSTRACT

This invention provides a moulded product having a first component (12), a second component (11) engaging a portion of the first component to form an interface (14) between the first and second component. The second component (11) includes a wall defining a cavity (24) having a wide interior (28) and a narrow entrance (26), at least a portion of the first component (12) being received in the wide 12 interior (28) and trapped by the narrow entrance (26) to connect to the first (12) and second component (11).

### FIELD OF THE INVENTION

This invention broadly relates to a moulded product and to a method of making a moulded product.

### BACKGROUND OF THE INVENTION

It is known to make moulded products by using injection moulding or blow moulding.

In blow moulding, a plastic material is heated to melt it and formed into a parison, generally a tube with an opening at one end. The parison is inserted into a mould and air is pumped into it, so that the soft plastic is expanded to conform to the shape of the mould. The plastic is then cooled and taken out of the mould.

In injection moulding, plastic material is heated to melt it and fed into a mould where it cools and conforms to the configuration of the mould, from which the moulded product is then removed.

It is known to make products using a combination of blow moulded and injection moulded components. The use of a combination may be desirable to provide different structural features to a finished product, or a convenient way to enable different colour or design features in the finished product.

When a product is to combine an injection moulded component and a blow moulded component, the injection moulded component may be formed first and then placed in the blow mould. The parison may then be inserted in the blow mould. After air is pumped into the blow mould, the parison should expand into the shape of the mould, contacting the injection moulded component. The finished product has the blow moulded component inside the injection moulded component.

A drawback with such a product having a blow moulded component and an injection moulded component can arise in that the contact between the blow moulded component and the injection moulded component may leave gaps between the components. This can be especially undesirable if the product is intended as, for example, a training cup for small children, since a child's small fingers may be trapped in the gaps and caused injury. Gaps can be undesirable for other items, even for adults, since lips, for example may be caught in gaps.

In addition, the interface between the blow moulded component and the injection moulded component may not be firm or secure and one may be movable with respect to the other. In severe cases, the product may fall apart, or be prised apart, the injection moulded component being separated from the blow moulded component.

It is an object of the present invention to provide a product which, at least in some embodiments, is capable of avoiding these problems, and of providing a method of making such a product.

### SUMMARY OF THE INVENTION

Accordingly, in a first aspect, the invention provides a moulded product having a first component, and a second component engaging a portion of the first component to form an interface between the first and second components. The second component includes a wall defining a cavity having a wide interior and a narrow entrance. The portion of the first component is received within the wide interior and trapped by the narrow entrance to connect the first and second components.

In a second aspect, the present invention provides a method of manufacturing a moulded product having a first component and a second component, the method including the steps of:
forming the first component;
providing a mould for the product, the mould being adapted to accommodate the first component and to enable the second component to engage the first component;
inserting the first component into the mould;
inserting a parison for the second component into the mould within the first component; and
inserting air into the parison so that it forms the second component and engages the first component.

In a third aspect, the present invention also provides a product made by the method of the invention.

In a fourth aspect, the present invention provides a moulded product having a first component and a second component. The first component is at least partially surrounding the second component, and the first component includes at least one aperture exposing the second component.

The first and second components may be made of any suitable plastic. Both may be made of the same material such as polyethylene or polypropylene, for example, or of different materials. Preferably, the first component is made by injection moulding, but the invention is not limited to this.

In the method of the invention, the second component is formed by inserting air into 20 the parison, or blow moulding. The product of the invention in the first aspect is not limited to this method of manufacture, since technology may provide alternates in the future.

The method of the invention causes the second component to engage the first component by wrapping around the first component. Essentially, this may form the cavity in the interface of the first aspect of the invention, trapping the first component.

In this way, the first component may be interlocked with the second component, ensuring that there are no undesirable gaps between the first and second components and also avoiding undesirable movement of one component with respect to the other.

The first and second components may take any desired shape, having regard to the purpose of the end product. The product of the first and third aspects may have more than one first component and/or more than one second component.

For convenience below, the invention will be described in more detail with reference to a training cup. However, it is to be understood that the invention is not limited to this example.

### BRIEF DESCRIPTION OF THE DRAWINGS

Possible and preferred features of the present invention will now be described with particular reference to the accompanying drawings. However, it is to be understood that the features illustrated in and described with reference to the drawings are not to be construed as limiting on the scope of the invention. In the drawings:

FIG. 1 shows a side elevation of a first embodiment of a product according to the first and third aspects of the invention and made according to the second aspect of the invention;

FIG. 2 shows an enlarged partial cross-sectional view, taken along the line X-X in FIG. 1;

FIG. 3 shows in enlarged partial cross-sectional view a variation of the view of FIG. 2;

FIG. 4 shows in enlarged partial cross-sectional view a second variation of the view of FIG. 2;

FIG. 5 shows in enlarged partial cross-sectional view a third variation of the view of FIG. 2;

FIG. 6 is a perspective view of the product of FIG. 1; FIGS. 7 to 12 each shows a side elevation of a further embodiment of a product according to the first and third aspects of the invention and made according to the second aspect of the invention; and

FIG. 13 shows an enlarged partial cross-sectional view, taken along the line Y-Y of FIG. 8 or Z-Z of FIG. 7.

### DETAILED DESCRIPTION OF THE DRAWINGS

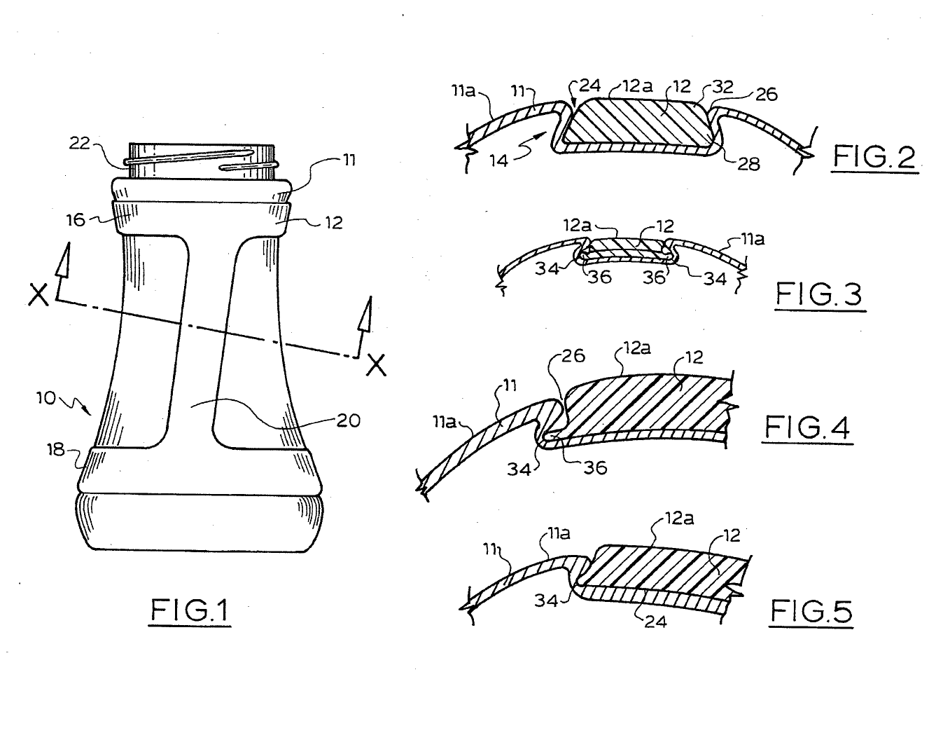

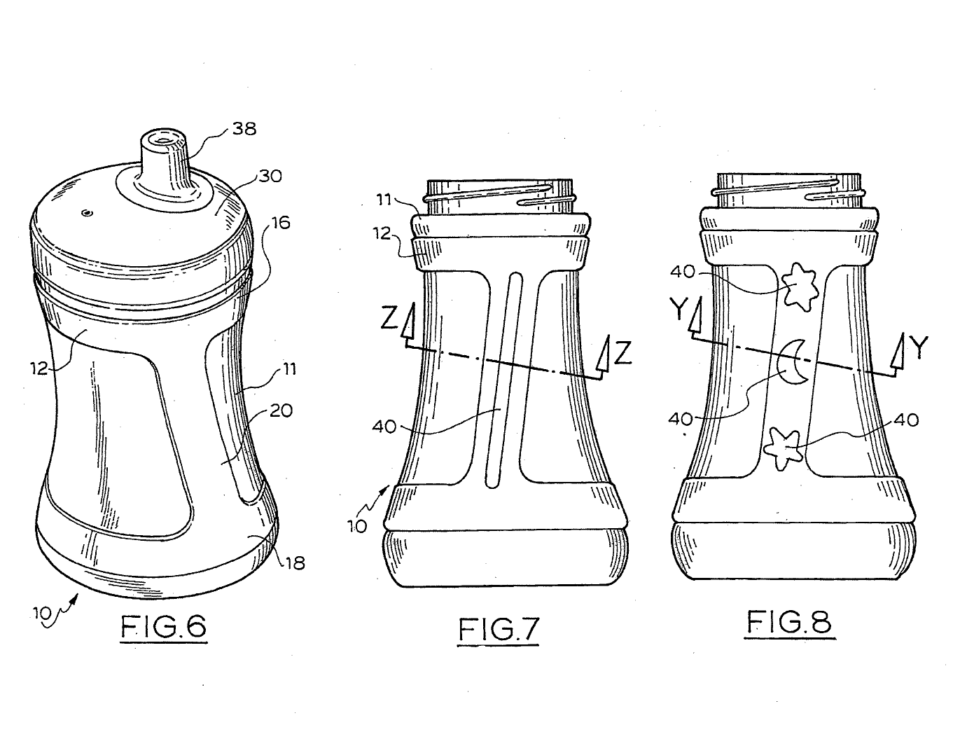

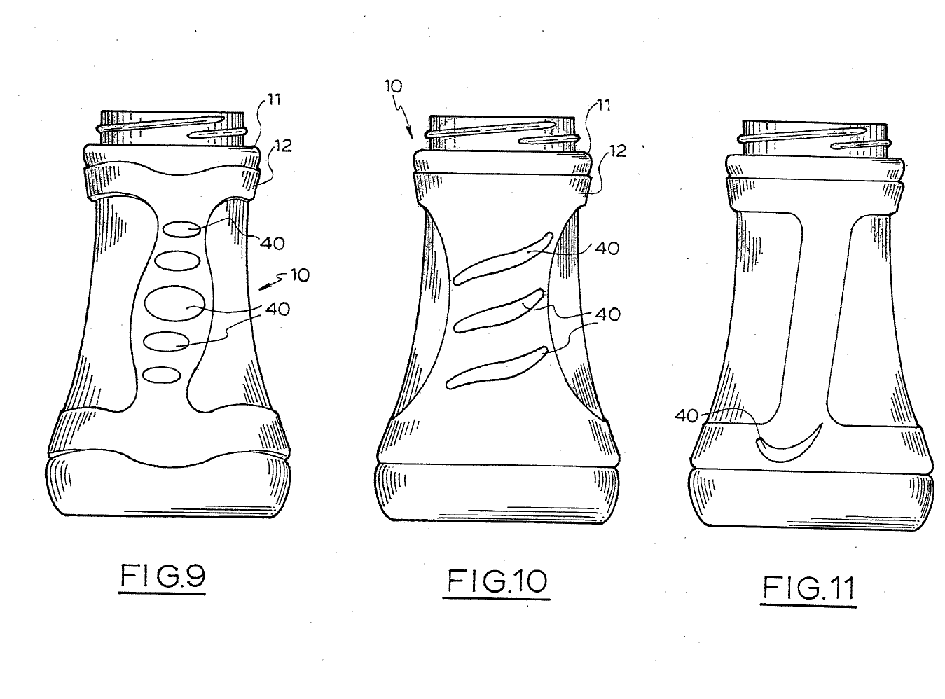

Referring first to FIG. 1, training cup 10, shown here without its lid, is made of a single first component 12 and a single second component 11. Second component 11 is generally inside first component 12, except as provided by interface 14 (refer FIGS. 2 10 to 5). First component 12 in this embodiment has first and second circumferential rings 16 and 18, joined or fused by bar 20. Training cup 10 has a screw-threaded mouth 22, ready to accept a lid 30 (refer FIG. 6).

As can be seen in FIG. 2, interface 14 is formed between first component 12 and second component 11. The second component 11 includes a wall 11a defining cavity 24. In the FIG. 2 embodiment, cavity 24 is generally trapezoidal in the illustration, being narrower at entrance 26. The cross-sectional shape of first component 12 generally echoes the cross-sectional shape of cavity 24, being received within it. First component 12 is wider at point 28 and narrower at point 32, so that first component 12 is trapped within cavity 24. In this embodiment, an outer surface 12a of first component 12 is 20 generally flush with a portion of wall 11a at entrance 26, so that first component 12 and second component 11 present a relatively unbroken circumference in training cup 10.

In the variation in FIG. 3, cavity 24 extends into ears 34 and first component 12 has corresponding extensions 36. In this embodiment, once again the outer surface 12a of first component 12 is generally flush with the portion of wall 11a at entrance 26.

In the variation in FIG. 4, cavity 24 extends into ears 34 and first component 12 has corresponding extensions 36, as in FIG. 3. However, in this embodiment, the outer surface 12a of first component 12 stands proud of entrance 26, so that first component 12 is more pronounced in training cup 10.

The variation in FIG. 5 has similar ears 34 in cavity 24, but first component 12 more closely echoes the shape of cavity 24.

In each of the embodiments shown in FIGS. 2 to 5, first component 12 is trapped or locked within cavity 24.

In FIG. 6, training cup 10 has lid 30 with drinking spout 38. In this embodiment, cup 10 is provided in two colours, being a lighter colour for first component 12 and a darker colour for second component 11. This may be a design feature, and/or first component 12 may provide structural strength to training cup 10.

FIGS. 7 to 12 show further embodiments of cup 10. In each embodiment, there is a location 40 where second component 11 is visible within first component 12. Only some of locations 40 are labelled in FIGS. 9 and 12. In each case, location 40 may take two configurations.

The first configuration does not include the cavity described above with the narrow entrance. In this configuration, locations 40 represent a design features and do not provide any locking together of components 11 and 12.

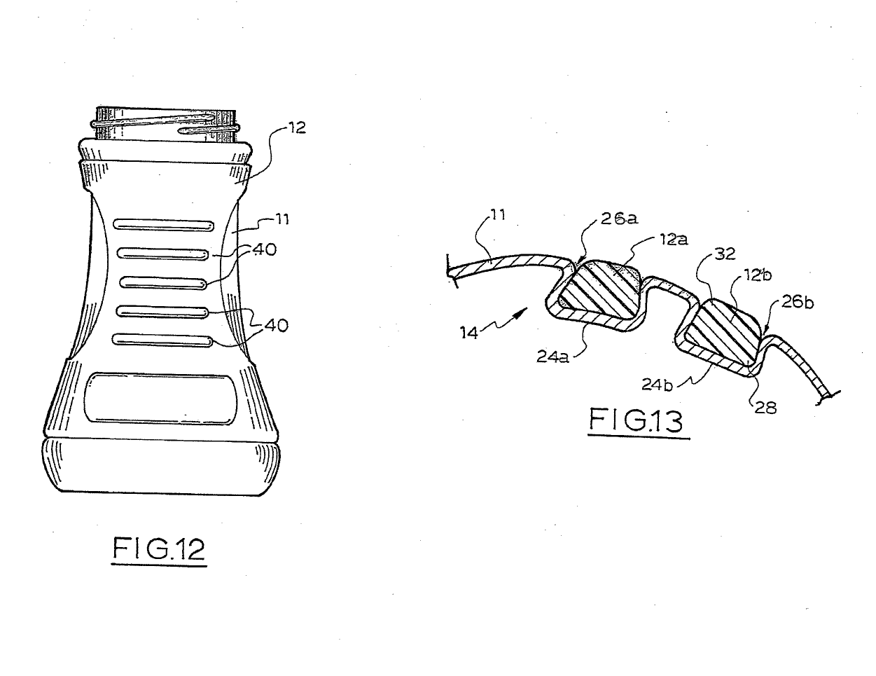

In the second configuration, locations 40 do provide the entrapment of part of the first component 12 by the second component 11. An example is illustrated in FIG. 13, which represents a cross-section along the line Z-Z in FIG. 7 or Y-Y in FIG. 8.

As can be seen in FIG. 13, interface 14 has two cavities, 24a and 24b, each similar to cavity 24 in FIG. 2. Each cavity 24a and 24b is generally trapezoid, being narrower at entrance 26a and 26b. The cross-sectional shape of first component 12 at 12a and 12b generally echoes the cross-sectional shape of cavity 24a and 24b respectively, being received within it. Each of first components 12a and 12b is wider at point 28 and narrower at point 32, so that each first component 12a and 12b is trapped within cavity 24a and 24b respectively. In this embodiment, first component parts 12a and 12b are generally flush with entrance 26a and 26b, so that first component 12 and second component 11 present a relatively unbroken circumference in training cup 10. However, as an alternative, parts 12a and 12b of first component 12 may be designed to stand proud of entrances 26a and 26b.

The method of manufacturing training cup 10 will now be described.

First component 12 is made by injection moulding in known manner, cooled and removed from its mould. First component 12 is then inserted into a mould for cup 10.

The mould (not shown) is designed to produce either a cup 10 having a relatively smooth circumference, as in FIG. 2, or a cup 10 in which first component 12 protrudes, as in FIG. 4.

The cross-sectional shape of first component 12, being narrower at the end (point 32 in FIG. 2) which will be on the outside of cup 10, but wider at the other end (point 28 in

FIG. 2), ensures that second component 11, when expanded, will at least partially wrap around first component 12.

The material for second component 11 is melted, formed as a parison and inserted into the mould, within first component 12. Air is pumped into the parison so that it expands and forms second component 11 and at least partially wraps around first component 12.

### INDUSTRIAL APPLICABILITY

It will be appreciated by those skilled in the art that many modifications and variations may be made to the embodiments described herein without departing from the spirit or scope of the invention. In particular, the invention provides a product particularly suitable for a training cup for small children and also for items wherein gaps may be undesirable.

1. A moulded product having:
a first component; and
a second component engaging a portion of the first component to form an interface between the first and second components, wherein the second component includes a wall defining a cavity having a wide interior and a narrow entrance, the portion of the first component being received within the wide interior and trapped by the narrow entrance to connect the first and second components.

2. The moulded product of claim 1, wherein each of the first and second components is chosen from polyethylene and polypropylene.

3. The moulded product of claim 1, wherein the first and second components are made of the same material.

4. The moulded product of any one of claims 1, wherein the first component is formed by injection moulding.

5. The moulded product of any one of claims 1, wherein the second component is formed by blow moulding.

6. The moulded product of any one of claims 1, wherein the first component has a cross-sectional shape corresponding to a cross-sectional shape of the cavity.

7. The moulded product of any one of claims 1 te-6, wherein the first component includes a top surface which is generally flush with a portion of the wall at the entrance of the cavity so that the first component and the second component form a generally unbroken outer surface.

8. The moulded product of claim 7, wherein the moulded product is a drinking vessel having a circumference, the first component including first and second circumferential rings fused by a bar.

9. A method of manufacturing a moulded product having a first component and a second component, the method including the steps of:
forming the first component;
providing a mould for the product, the mould being adapted to accommodate the first component and to enable the second component to engage the first component;
inserting the first component into the mould;
inserting a parison into the first component; and
inserting air into the parison to form the second component and at least partially wrap around the first component.

10. The method of claim 9, wherein each of the first and second components is chosen from polyethylene and polypropylene.

11. The method of claim 10, wherein the first and second components are made of the same material.

12. The method of any one of claims 9, wherein the first component is made by injection moulding.

13. (canceled)

14. A moulded product having:
a first component; and
a second component, the first component at least partially surrounding the second component, wherein the first component includes at least one aperture exposing the second component.
